(19) United States
(12) Patent Application Publication
(10) Pub. No.: US 2010/0222639 A1
(43) Pub. Date: Sep. 2, 2010

(54) HEARING DEVICE HAVING A NON-OCCLUDING IN THE CANAL VIBRATING COMPONENT

(75) Inventors: Christopher Purcell, Dartmouth (CA); Richard Fleming, Fall River (CA); David P. Morris, Halifax (CA); Manohar Bance, Halifax (CA)

Correspondence Address: CONNOLLY BOVE LODGE & HUTZ LLP, 1875 EYE STREET, N.W., SUITE 1100, WASHINGTON, DC, 20006, US

(73) Assignees: COCHLEAR LIMITED, Lane Cove, NSW (AU); EAROTECH., INC., Halifax, Nova Scotia (CA)

(21) Appl. No.: 12/373,887

(22) PCT Filed: Jul. 27, 2007
(86) PCT No.: PCT/US07/74667

§ 371 Date: Nov. 30, 2009

Related U.S. Application Data
(60) Provisional application No. 60/833,681, filed on Jul. 27, 2006.

(51) Int. Cl. H04R 25/00

(52) U.S. Cl. 600/25

(57) ABSTRACT

A self-retaining bone conduction hearing device having a sound processor (104) and a nonoccluding in-the-canal vibrating component (108) responsive to the sound processor and configured for non-surgical-implantation in a recipient's ear canal. Utilizing bone conduction eliminates the dependency on acoustic stimulation, thereby enabling the hearing device of the present invention to address a wider range of sound frequencies in conductive hearing loss.

### CROSS-REFERENCE TO RELATED APPLICATIONS

The present application claims priority from U.S. Provisional Patent Application No. 60/833,681 filed on Jul. 27, 2006 entitled “Bone Conduction Hearing Device and Method”, which is hereby incorporated by reference herein.

### BACKGROUND

1. Field of the Invention

The present invention relates generally to hearing devices and, more particularly, to a hearing device having a non-occluding in-the-canal vibrating component.

2. Related Art

Hearing loss is generally of two types, conductive and sensorineural. The treatment of both of types of hearing loss has been quite different, relying on different principles to deliver sound signals to be perceived by the brain as sound.

Sensorineural hearing loss is due to the absence or destruction of the cochlear hair cells which transduce acoustic signals into auditory nerve impulses. Individuals suffering from sensorineural hearing loss are unable to derive any benefit from conventional hearing aids due to the absence of, or damage to, the natural mechanisms that transduce sound energy into auditory nerve impulses. In such cases, cochlear™ implants have been developed. Cochlear implants provide electrical stimulation to the auditory nerve via stimulating electrodes positioned adjacent to the auditory nerve, essentially bypassing the hair cells of the cochlea. Application of an electrical stimulation pattern to the auditory nerve endings causes impulses to be sent to the brain, resulting in sound perception.

Conductive hearing loss occurs when the normal mechanical pathways for sound to reach the hair cells in the cochlea are impeded, for example, by damage to the ossicles. In such cases, hearing loss is often improved with the use of conventional hearing aids, which amplify sound. Such hearing aids utilize acoustic mechanical stimulation, whereby the sound is amplified according to a number of varying techniques, and is delivered to the inner ear as mechanical energy. This may be through a column of air to the eardrum, or through direct delivery to the ossicles of the middle ear.

One class of hearing device, referred to as air conduction devices, delivers the mechanical energy by delivering a column of air to the eardrum. Such air conducting devices work by collecting ambient sound with a microphone, amplifying the sound and delivering the amplified signal by way of a speaker positioned in the outer portion of the ear canal.

Another class of device, referred to as middle ear implants, delivers the mechanical energy by directly delivering the mechanical energy to the ossicles of the middle ear. Such middle ear implants work by collecting ambient sound with a microphone, processing the sound and vibrating a rod implanted adjacent a bone in the ossicular chain, or adjacent the oval window of the cochlea.

A further class of device, referred to as a bone anchored hearing aid, converts incoming sound into mechanical vibrations that are transmitted to the bone structure of the skull. The resulting skull vibrations stimulate the cochlea, resulting in a perceived sound. The direct bone conduction provided by a bone anchored hearing aid has been utilized as a treatment for conductive and mixed hearing losses as well as for the treatment of unilateral sensorineural hearing loss. Typically, a bone anchored hearing aid is used to help people with chronic ear infections, congenital external auditory canal atresia and single sided deafness, as such persons often cannot benefit from conventional hearing aids. Conventional bone anchored hearing aid devices are surgically implanted to allow sound to be conducted through the bone rather than via the middle ear.

### SUMMARY

In one aspect of the present invention, a self-retaining bone conduction hearing device is disclosed, the hearing device comprising: a sound processor; and a non-occluding in-the-canal vibrating component responsive to the sound processor and configured for non-surgical-implantation in a recipient's ear canal.

### BRIEF DESCRIPTION OF THE DRAWINGS

Embodiments of the present invention will be described below with reference to the attached drawings, in which:

FIG. 1 is a high-level functional block diagram of a bone conduction hearing device having a non-occluding in-the-canal vibration transducer assembly, in accordance with one embodiment of the present invention;

FIG. 2 is a high-level functional block diagram of a bone conduction hearing device having a non-occluding in-the-canal vibrating element, in accordance with one embodiment of the present invention;

FIG. 3 is a high-level functional block diagram of a bone conduction hearing device having a vibration transducer configured to be self-retained in the conchal bowl of the human ear, and a non-occluding in-the-canal vibration transducer assembly, in accordance with one embodiment of the present invention;

FIG. 4 is a high-level functional block diagram of a bone conduction hearing device having a vibration transducer configured to be self-retained in the conchal bowl of the human ear, and a non-occluding in-the-canal vibrating element controlled by a second vibration transducer configured to be self-retained in the conchal bowl of the human hear, in accordance with one embodiment of the present invention;

FIG. 5 is a partial cross-sectional view of a human auditory system;

FIG. 6A is a perspective view of a bone conduction hearing device in accordance with one embodiment of the present invention;

FIG. 6B is a perspective view of the bone conduction hearing device of FIG. 6A shown implanted in a recipient's outer ear;

FIG. 6C is a perspective view of the bone conduction hearing device, in accordance with an alternative embodiment of the present invention;

FIG. 7 is a schematic diagram showing the direction of movement which may be implemented in various embodiments of the non-occluding in-the-canal vibrating component of the present invention;

FIG. 8 is a perspective view of a piezoelectric vibration transducer assembly for insertion in the ear canal, in accordance with one embodiment of the present invention;

FIG. 9 is a front view of the non-occluding in-the-canal vibration transducer assembly in accordance with an alternative embodiment of the present invention;

FIG. 10 is a front view of the non-occluding in-the-canal vibration transducer assembly in accordance with an alternative embodiment of the present invention;

FIG. 11 is a front view of the non-occluding in-the-canal vibration transducer in accordance with an alternative embodiment of the present invention;

FIG. 12 is a perspective view of an alternative embodiment of the bone conduction hearing device shown implanted in a recipient's ear;

FIG. 13 is a front view of an adjustable non-occluding in-the-canal vibrating component, in accordance with an embodiment of the present invention;

FIG. 14 is a front view of an adjustable non-occluding in-the-canal vibrating component, in accordance with another embodiment of the present invention;

FIG. 15 is a front view of an adjustable non-occluding in-the-canal vibrating component, in accordance with a further embodiment of the present invention;

FIG. 16 is a front view of an adjustable non-occluding in-the-canal vibrating component, in accordance with a still further embodiment of the present invention;

FIG. 17 is a schematic view of a hearing device having an external vibration transducer and a passive in-the-canal vibrating element, in accordance with one embodiment of the present invention; and

FIG. 18 is a schematic view of a hearing device having two external vibration transducers and a passive in-the-canal vibrating element, in accordance with another embodiment of the present invention.

### DETAILED DESCRIPTION

Aspects of the present invention are generally directed to a self-retaining bone conduction hearing device having a sound processor and a non-occluding in-the-canal vibrating component responsive to the sound processor and configured for non-surgical-implantation in a recipient's ear canal. Utilizing bone conduction eliminates the dependency on acoustic stimulation, thereby enabling the hearing device of the present invention to address a wider range of sound frequencies in conductive hearing loss.

Unlike conventional hearing devices having an in-the-canal component, the hearing device of the present invention does not occlude the ear canal nor does it interrupt the ossicular chain. In other words, the present invention does not interfere with a recipient's remaining natural hearing nor the normal biological functioning of the ear. For example, embodiments of the present invention facilitate the normal egress of cerumen (ear wax) and the normal circulation of air, thereby reducing the likelihood of external ear infections, allergic response and intolerance.

The human auditory system includes the outer ear, the middle ear and the inner ear. In a fully functional ear, the outer ear comprises an auricle or pinna and an ear canal. An acoustic pressure or sound wave is collected by the auricle and channeled into and through the ear canal. Disposed across the distal end of the ear cannel is a tympanic membrane which vibrates in response to the acoustic wave. This vibration is coupled to the oval window of the cochlea through three bones of the middle ear, collectively referred to as the ossicles or ossicular chain. The ossicles serve to filter and amplify the acoustic wave, causing the oval window to vibrate. Such vibration sets up waves of fluid motion within the cochlea. Such fluid motion, in turn, activates tiny hair cells that line the inside of the cochlea. Activation of the hair cells causes appropriate nerve impulses to be transferred through the spiral ganglion cells and auditory nerve to the brain, where they are perceived as sound.

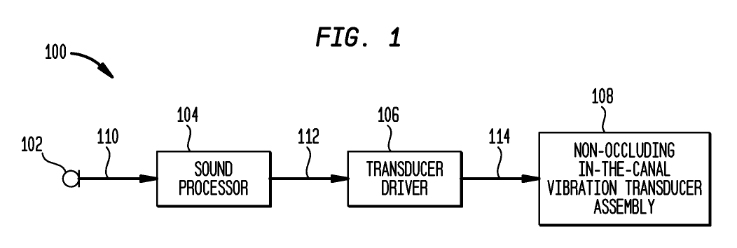

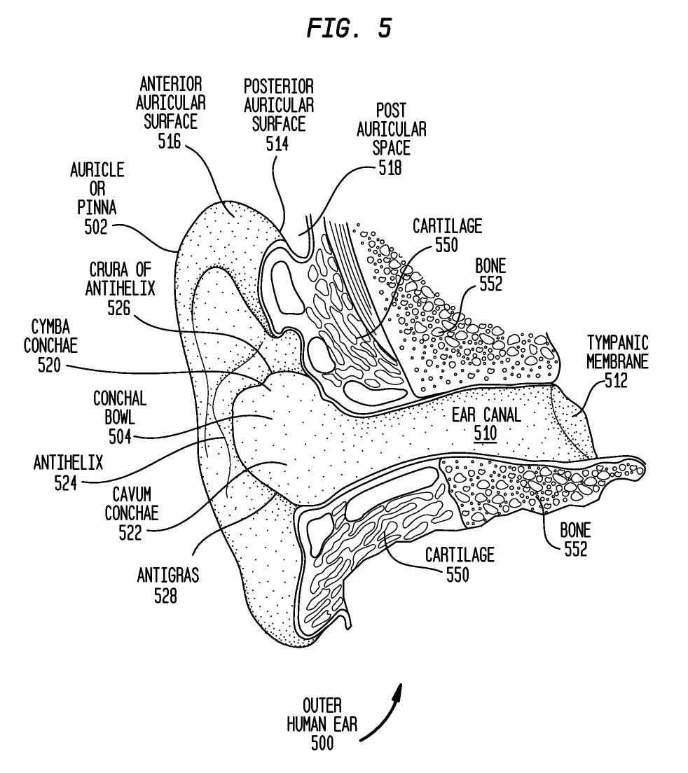

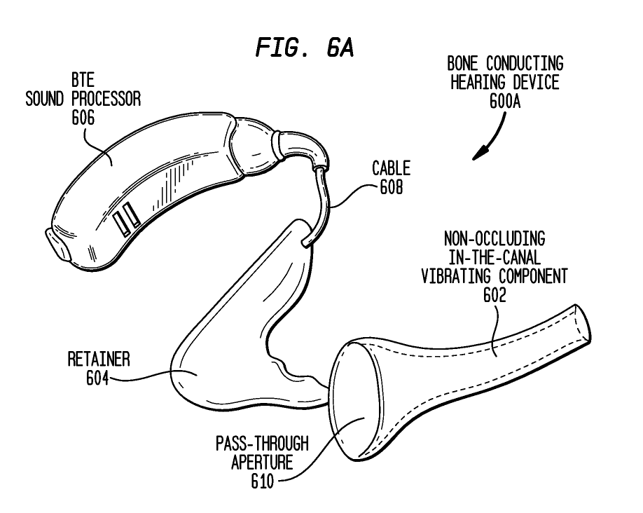

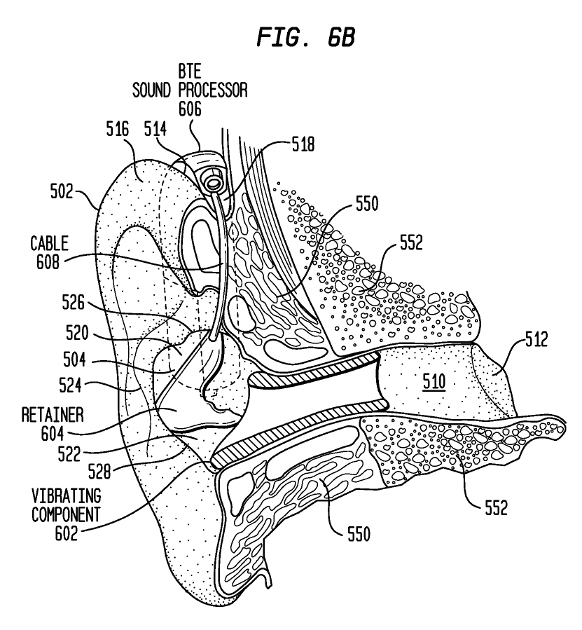

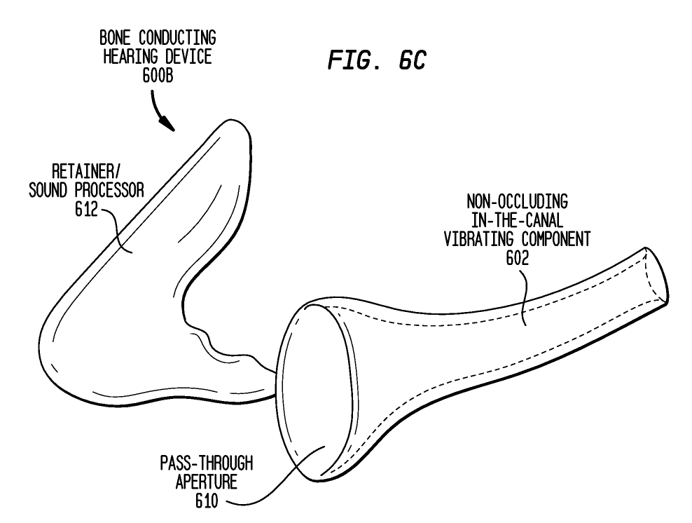

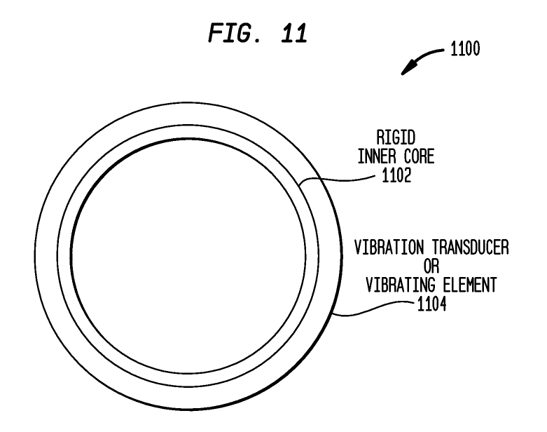

Embodiments of the present invention are described next below with reference to a variety of functional block diagrams in FIGS. 1-4. Then, the human outer ear is described in greater detail with reference to FIG. 5. Thereafter, the invention will be described with reference to FIGS. 6-18 illustrating examples of how the functional components described in FIGS. 1-4 may be implemented.

As noted, aspects of the present invention are directed to a self-retaining bone conduction hearing device having a non-occluding vibrating component configured for non-surgical-implantation in a recipient's ear canal. FIG. 1 is a high-level functional block diagram of one embodiment of a bone conduction hearing device in which the non-occluding in-the-canal vibrating component is a passive device; that is, it does not contain a transducer. Hearing device 100 comprises a microphone 102 that converts received ambient sound to electrical signals 104 representative of the received sound. Microphone 102 may be a traditional miniature hearing aid microphone, and is preferably flexibly mounted to minimize the impact of shock and to resist pick-up of extraneous noise. More than one microphone, for example, an array of microphones, may be employed in alternative embodiments. Multiple microphones may allow selectable modes of sound reception, for example, speech focused in front of the user versus multi-directional sound. Sound sensed through microphone 102 may be transduced by microphone 102 into electrical signals 110 for sound processor 104.

Sound processor 104 processes electrical signals 110 to generate stimulation command signals 112. In one embodiment, sound processor 104 comprises analog or digital circuits to amplify, filter, and optimize the sound information received from microphone 102. Sound processor 104 may further convert the information into a format suitable for transmission to transducer driver 106. Sound processor 104 may optionally contain control circuits accessible via a user interface. Such an interface provides user control to certain parameters associated with the operation of hearing device 100, such as the amplitude of the bone vibrations, or the frequencies of the signals (that is, tone control) that are to be processed. As such, the user interface may include an on/off switch, a volume control, capability to switch between various sound processing strategies or hearing profiles, an indicator of remaining power, and the like.

Any type of signal or sound processing may be employed, as is known in the hearing aid art (for example, different frequency responses), in order to enhance the ability of the recipient to benefit from the sound amplification. Different signal processing strategies may be selected through the user interface, and may be modified, from time to time, as needed or desired.

Sound processor 104 is configured to exchange information with an external programming unit to allow an audiologist or clinician to initially program or “fit” hearing device 100 with a customized hearing profile(s), or make programming adjustments after some amount of use, so that it optimally meets the needs and preferences of the recipient. Fitting may include adjusting hearing device 100 to utilize a desired frequency response or signal processing strategy.

Preferably, sound processor 104 may also accept direct input from commercial electronics devices, such as telephones (land line or cellular network such as USTM network), computers, personal digital assistants, televisions, DVD players, CD players, AM/FM and/or two way radios, and the like.

Sound processor 104 sends vibration commands 112 to vibration transducer assembly 108 via a transducer driver 106. Transducer driver 106 converts commands 112 to an appropriate form and format 114 suitable for the particular embodiment of non-occluding in-the-canal vibration transducer assembly 108. Transducer driver 106 transmits drive signals 114 to a vibration transducer 108. Vibration transducer assembly 108, which is securely implanted in a recipient's ear canal, transduces the sound information to physical movement in the form of vibrations. Vibration transducer assembly 108 vibrates in a manner that the sound information is provided to the recipient's auditory nerve via bone conduction through the recipient's skull.

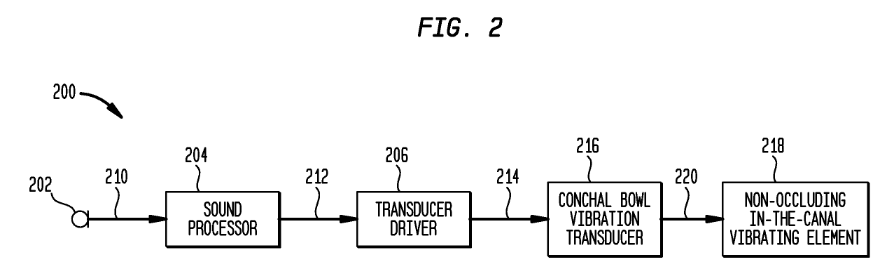

FIG. 2 is a functional block diagram of another embodiment of a bone conducting hearing device of the present invention, referred to herein as hearing device 200. Hearing device 200 comprises a microphone 202, sound processor 204, and transducer driver 206 which operate in a manner which is the same or similar as or similar to microphone 102 and sound processor 104, described above with reference to FIG. 1. Accordingly, these components of hearing device 200 are not described further herein.

In this embodiment, hearing device 200 further comprises a conchal bowl vibration transducer 216. As will be described in greater detail below, vibration transducer 216 is configured to be self-retained in the conchal bowl of the recipient's outer ear. Vibration transducer 216 causes a passive non-occluding in-the-canal vibrating element to vibrate in a manner that the sound information is provided to the recipient's auditory nerve via bone conduction through the recipient's skull.

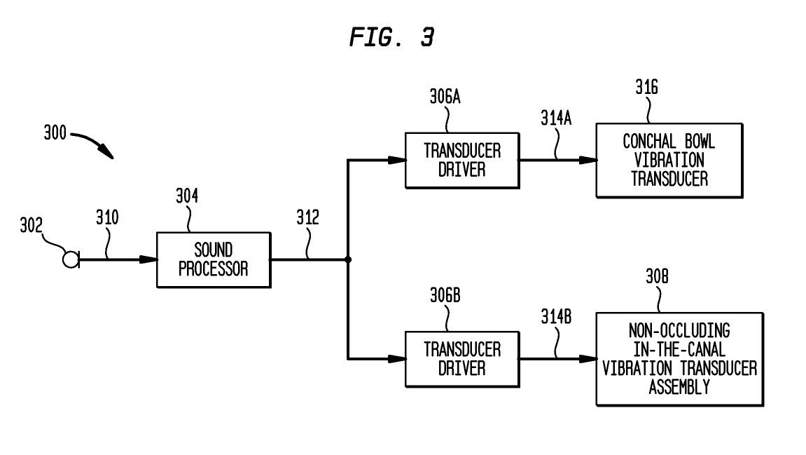

FIG. 3 is a functional block diagram of another embodiment of a bone conducting hearing device of the present invention, referred to herein as hearing device 300. Hearing device 300 comprises a microphone 302, sound processor 304, and transducer drivers 306A, 306B, all of which operate in a manner which is the same as or similar to microphone 102, sound processor 104 and transducer driver 106, described above with reference to FIG. 1. Accordingly, these components of hearing device 300 are not described further herein.

In this embodiment, hearing device 300 comprises a conchal bowl vibration transducer 316. As will be described in greater detail elsewhere herein, vibration transducer 316 is configured to be self-retained in the conchal bowl of the recipient's outer ear. Vibration transducer 316 vibrates in response to sound processor 304 to convert incoming sound into mechanical vibrations that are transmitted to the bone structure of the skull.

In this exemplary embodiment, hearing device 300 also comprises a non-occluding in-the-canal vibration transducer assembly 308 that also vibrates in response to sound processor 304 to convert incoming sound into mechanical vibrations that are transmitted to the bone structure of the skull. Non-occluding in-the-canal vibration transducer assembly 308 operates in a manner similar to vibration transducer 108 and, as such, is not described further herein.

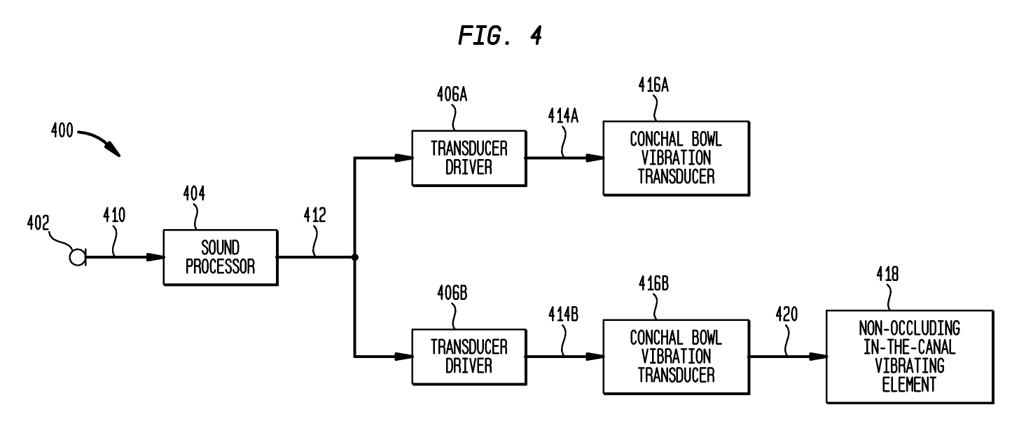

FIG. 4 is a functional block diagram of another embodiment of a bone conducting hearing device of the present invention, referred to herein as hearing device 400. Hearing device 400 comprises a microphone 402, sound processor 404, and transducer drivers 406A, 406B, all of which operate in a manner which is the same as or similar to microphone 102, sound processor 104 and transducer driver 106, described above with reference to FIG. 1. Accordingly, these components of hearing device 400 are not described further herein.

In this embodiment, hearing device 400 comprises a conchal bowl vibration transducer 416A. As will be described in greater detail elsewhere herein, vibration transducer 416A is configured to be self-retained in the conchal bowl of the recipient's outer ear. Vibration transducer 416A vibrates in response to sound processor 304 to convert incoming sound into mechanical vibrations that are transmitted to the bone structure of the skull.

In this embodiment, hearing device 400 also comprises a conchal bowl vibration transducer 416B that invokes vibrational movement in a non-occluding in-the-canal vibrating element 418 implanted in the recipient's ear canal. As will be described in greater detail below, vibration transducer 416B is configured to be self-retained in the conchal bowl of the recipient's outer ear.

FIG. 5 is a combined perspective and cross-sectional view of an outer ear 500 of a human recipient. Outer ear 500 comprises an auricle or pinna 502 and an ear canal 510. An acoustic pressure or sound wave is collected by auricle 502 and channeled into and through ear canal 510 to vibrate tympanic membrane 512 disposed across the distal end of ear cannel 510.

A posterior surface 514 of auricle 502 is spaced from the recipient's skull forming a post-auricular space 518. The anterior surface 516 of auricle 502 comprises a variety of features for facilitating the collection and channeling of sound waves into ear canal 510. Relevant features include the raised ridge formed by the crura of antihelix 526, antihelix 524, and antigras 528, which collectively form a raised perimeter of conchal bowl 504. Conchal bowl 504 comprises two regions, cymba conchae 520 and cavum conchae 522.

Exemplary implementations of hearing devices 100, 200, 300, and 400 are described next below with reference to FIGS. 6A-6C. FIGS. 6A-6C are first described followed by a detailed description of the components of the hearing devices illustrated in FIGS. 6A-6C.

FIG. 6A is a perspective view of one embodiment of a bone conducting hearing device of the present invention, referred to herein as bone conducting hearing device 600A. Hearing device 600A comprises a behind-the-ear sound processor 606, a non-occluding in-the-canal vibrating component 602, and a retainer 604 secured to the proximal end of vibrating component 602. Sound processor 606 controls vibrating component 602 via a cable 608 which is passed through retainer 604.

FIG. 6B is a perspective view of hearing device 600A implanted in outer ear 500 of a recipient. Behind-the-ear sound processor 606 is positioned in post-auricular space 518. Cable 608 extends from sound processor 606 to retainer 604. Retainer 604 is configured to be self-retained in conchal bowl 504 and, more specifically, in cymba conchae 520 of conchal bowl 504. Vibrating element 602 is configured to be implanted in ear canal 510, and is preferably designed for or fitted to the particular ear canal 510. As such, retainer 604 in combination with the secure fitting of vibrating component 602 in ear canal 510, and the behind-the-ear location of sound processor 606 retain hearing device 600A in the recipient's outer ear 500.

Vibrating element 602 has a pass-through aperture 610 to permit the passage of bodily fluids, air and sound. Thus, vibrating component 602 is referred to herein as a non-occluding in-the-canal vibrating component 602.

FIG. 6C is a perspective view of another embodiment of a bone conducting hearing device of the present invention, referred to herein as bone conducting hearing device 600B. Bone conducting hearing device 600B comprises a non-occluding in-the-canal vibrating component 602 as introduced above. A retainer/sound processor 612 is secured to the proximal end of vibrating component 602 so that it may be implanted in conchal bowl 504. Retainer/sound processor 612 is configured to be self-retained in conchal bowl 504. More specifically, retainer/sound processor 612 is configured to be self-retained in cymba conchae 520 and cavum conchae 522.

As noted above, vibrating element 602 is configured to be implanted in ear canal 510, and is preferably designed for or fitted to the particular ear canal 510. As such, retainer 612 in combination with the secure fitting of vibrating component 602 in ear canal 510 retain hearing device 600B in the recipient's outer ear 500.

Turning now to the components of hearing devices 600A, 600B, non-occluding in-the-canal vibrating component 602 is configured to be implanted in ear canal 510 to provide vibrations to cartilage 550 and, perhaps, bone 552 defining ear canal 510. Vibrating component 602 may be an active component, that is, it may comprise a vibration transducer. Embodiments of such a vibrating component 602 is vibration transducer assembly 108 and vibration transducer assembly 308. Alternatively, vibrating component 602 may be an inactive or passive vibrating element, that is, it may not comprise a vibration transducer. Thus, the term vibrating component refers to any embodiment of a non-occluding in-the-canal component that delivers vibrations to a recipient in response to a sound processor.

As noted, vibrating component 602 is non-occluding. That is, there is a pass-through aperture 610 that permits the passage of bodily fluids, air and sound. As such, embodiments of the present invention are particularly useful for use in recipients having conductive hearing loss and excessive drainage. In contrast to conventional approaches in which such drainage interferes with traditional acoustic hearing aids, embodiments of the present invention allow drainage through pass-through aperture 610.

The non-occluding aspect of vibrating component 602 leaves ear canal 510 open thereby avoiding the occlusion effect (the wearer's own voice sounds altered to themselves because of closing the ear canal accentuates the low frequencies heard in the voice) commonly provided by conventional hearing aids. Other key advantages of having ear canal 510 open are that the recipient may hear ambient sounds making the recipient more aware of his/her environment.

In the embodiments of vibrating component 602 illustrated in FIGS. 6A-6C and described elsewhere herein, vibrating component 602 has a pass-through aperture 610 generally in the center of the component. It should be appreciated, however, that in alternative embodiments, vibrating component 602 may be dimensioned to be disposed around only a portion of the periphery of ear canal 510, and may be non-contiguous. As such, the pass-through aperture may not be completely surrounded by a surface of vibrating component 602. For example, in one embodiment, vibrating transducer 602 is located only at the top of ear canal 510 thereby allowing ventilation, sound and bodily fluids travel through ear canal 510 via a pass-through aperture defined by vibrating component 602 and an opposing wall of ear canal 510. Thus, the vibrating component of the present invention is configured to be retained around the periphery of ear canal 510 when implanted in a recipient.

In the embodiments described herein, vibrating component 602 has a circular cross-section, whether due to it being ring-shaped or cylindrical-shaped. It should also be appreciated, however, that vibrating component 602 may have other cross-sectional shapes that provide one or more of the above-noted benefits associated with a non-occluding vibrating component. For example, in one embodiment, vibrating component 602 is ovoid.

As noted, hearing device 600A comprises a retainer 604 configured to be self-retained in cymba conchae 510 of conchal bowl 504, and hearing device 600B comprises a retainer/sound processor 612 configured to be self-retained in cymba conchae 510 and cavum conchae 522 of conchal bowl 504. Retainers 604, 612 contribute to the long-term retention of vibrating component 602 in ear canal 510. If necessary or desired, retainer 612 may be implemented to further contribute to the retention of vibrating component 602. It should be appreciated that such retention may also be aided by a postauricular extension such as behind-the-ear sound processor 606.

In one embodiment, the materials that retainers 604, 612 are made of are hypoallergenic materials. In certain embodiments one or both retainers 604, 612 are formed of Lucite or Silicone. Retainers 604, 612 may be molded from one of the materials used in traditional hearing aid molds. These materials are classified broadly into hard and soft or flexible materials. All such materials allow a snug, comfortable fit in ear canal 510, are easy to clean and remain stable without exciting an inflammatory tissue reaction (hypoallergenic).

In one embodiment, the hard mold material is an acrylic resin, which is inert and hypoallergenic. It does not distort with moisture and temperature changes and can be easily ground to make modifications to its shape. Flexible materials include soft acrylic, plastics and silicon. Soft acrylic molds show some deformation with increased temperatures making them less suitable for hot climates. Plastics including vinyl and polypropylene are more stable, but they tend to shrink and harden with time and typically require replacement after 18-24 months. Silicon polymer moulds such as MDX (peroxide catalyzed) are comfortable and inert.

Preferably, all molds will be custom fit to the individual ear canal 510. This procedure is quick and easy to perform, and uses a well-established technique familiar to all hearing aid technicians. A soft foam plug 502 is placed into the ear canal before soft silicon putty is injected and allowed to set. The impression is removed a few minutes later and can be used to make a more durable mold. The finished mold may then be canalized and the transducer inserted.

Retainers 604, 612 retain hearing device 600A, 600B in their operable position on the recipient without additional support and without surgical implantation. It should be appreciated, however, that this self-retaining feature of the bone conducting hearing device of the present invention may be provided by one or more components of the device. For example, in one embodiment, the in-the-canal component 602 is snugly fit within ear canal 510. In other embodiments, other components are configured to compliment the self-retaining function performed by the in-the ear component. For example, in one embodiment, passive molded retainer 604 is configured to snugly fit within conchal bowl 504 of the recipient. In a further embodiment, the connection of the in-the-canal component 602 with the behind-the-ear (BTE) component 606 residing in post-auricular space 518 further contributes to the self-retaining characteristic of the device. As one of ordinary skill in the art would appreciate, any combination of one or more of these or other features may be implemented in a hearing aid device to attain a desired or required degree of self-retention. This may be a function of, for example, the type of transducer, the mass of the device and the activity level of the recipient, among other factors.

It should also be appreciated that other techniques may be utilized to attain a desired degree of self-retention. For example, in one embodiment, piercing is utilized additionally or alternatively to the techniques described above. In another embodiment, the device may be retained by an elastic cloth covering the whole pinna and ear, which retains the device in place in the ear canal.

Behind-the-ear sound processor 606 is any sound processor now or later developed such as sound processor 104, 204 and 304.

As noted above with reference to FIGS. 6A-6C, vibrating component 602 may comprise non-occluding in-the-canal canal vibration transducer assembly 108, 308, and/or non-occluding in-the-canal canal vibrating element 208. Regardless of whether vibrating component 602 is active (108, 308) or passive (208), it operates to transfer vibrations to the recipient's skull.

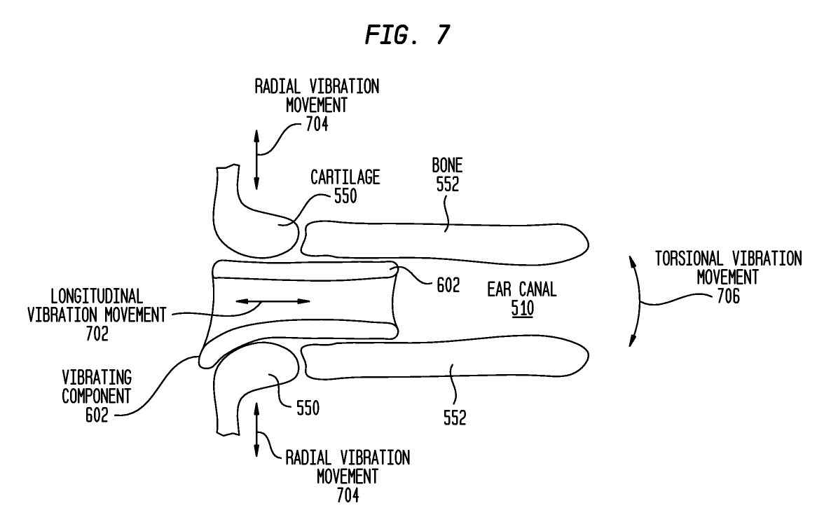

Different embodiments of vibrating component 602 may vibrate; that is, move, in different directions. This is referred to herein as the vibration mode of vibrating component 602. FIG. 7 is a schematic diagram of bone conducting hearing devices 600A, 600B implanted in a recipient's ear, also shown schematically. In this representative environment, vibrating component 602 extends past cartilaginous ear canal 550 into a portion of bony ear canal 552. It should be appreciated, however, that different depths of implantation may be implemented in connection with different vibrating modes to achieve a desired result.

Three different vibration modes are illustrated in FIG. 7. Radial vibration movement 704 occurs when vibrating component 602 expands and contracts. Longitudinal vibration movement 702 occurs when vibrating component 602 moves in and out of ear canal 510. And, torsional vibration movement 706 occurs when vibrating component 602 rotates or twists.

Different vibration modes 702, 704, 706 may be implemented to attain a desired or optimal transfer of sound information. For example, certain vibration modes at certain locations in ear canal 510 may optimally deliver certain frequencies or amplitudes. Such vibration modes 702, 704, 706 may be implemented in parallel in separately-controlled portions of vibrating component 602. It should be appreciated that torsional vibration movement 706 and longitudinal vibration movement 702 may impart shear stress to the epithelium of ear canal 510.

As noted, vibration transducer assemblies 108, 308 are non-occluding components of the hearing device which are non-surgically implanted in ear canal 510. In the exemplary embodiment illustrated in FIGS. 6A through 6C, vibration transducer assemblies 108, 308 comprise a non-occluding in-the-canal vibrating component 602 which, in FIGS. 6A-6C, has been over-molded to conform to ear canal 510.

As noted, vibration component 602 may be active or passive; that is, it may comprise a transducer or it may not. As described in detail next below, embodiments of vibration component 602 which are active, introduced above as vibration transducer assemblies 108, 308, may comprise one or more transducers and may take on a number of configurations.

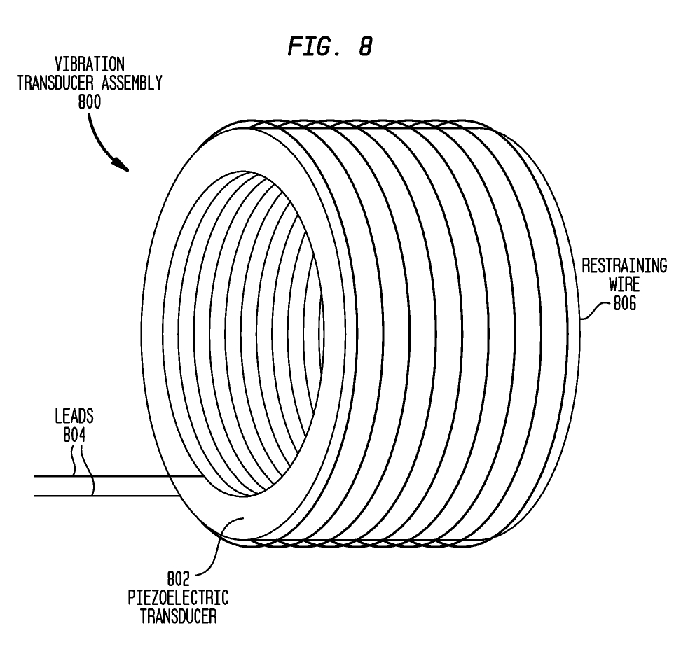

FIG. 8 is a perspective view of a vibration transducer assembly 800. Vibration transducer assembly 800 is configured to be retained around the periphery of ear canal 510 when implanted in a recipient.

As noted above with reference to FIGS. 6A-6C, vibrating component 602 has a pass-through aperture 610 that facilitates drainage, etc., as noted above. Accordingly, in this embodiment, vibration transducer assembly 800 has a substantially contiguous perimeter; that is, it is in the form of a cylinder dimensioned to be implanted in a recipient's ear canal 510 and to form pass-through aperture 610.

In this exemplary embodiment, vibration transducer assembly 800 is formed of a piezoelectric material; that is, it comprises a piezoelectric transducer 802. Piezoelectric materials are rigid ceramics which are responsive to a wide range of frequencies and amplitudes. To guard against fracture, this embodiment of vibration transducer assembly 800 comprises a pre-stressed fiberglass coating 806 wrapped around the cylindrical periphery of piezoelectric transducer 802 to provide a maximum radial extension.

Also shown in FIG. 8 are two leads 804 which are used to drive vibration transducer 800. Leads 804 are connected to a transducer driver 106, 306. As noted above with reference to FIG. 8, vibration transducer assembly 800 comprises a single piezoelectric transducer 802. It should be appreciated, however, that piezoelectric transducer 802 need not have the illustrated length; that is, it may be longer or shorter in length depending on the desired depth of insertion and therapeutic objectives. It should also be appreciated that more than one piezoelectric transducer 802 may comprise vibration transducer assembly 800. In one such embodiment, each piezoelectric transducer 802 is controlled separately by sound processor 104, 304 via a dedicated driver 106, 306.

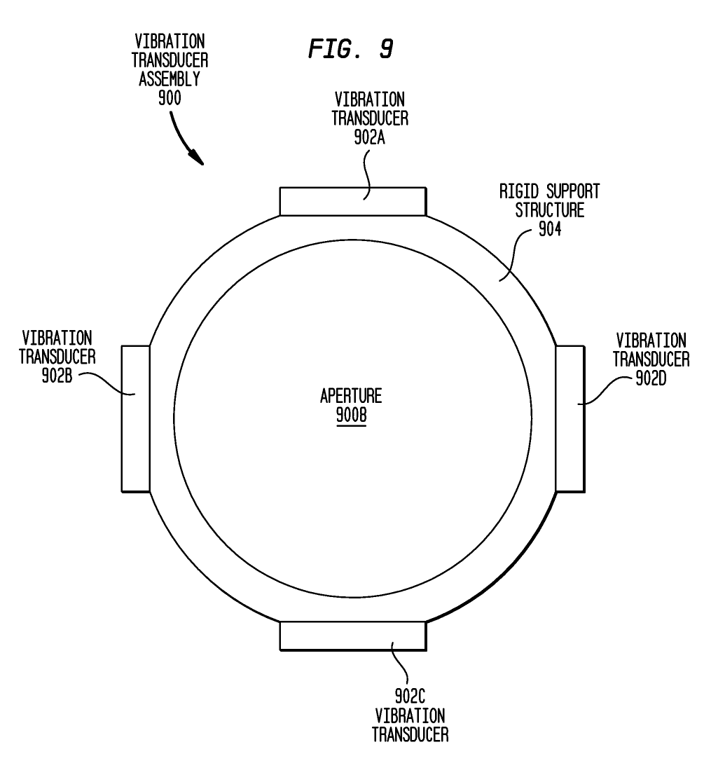

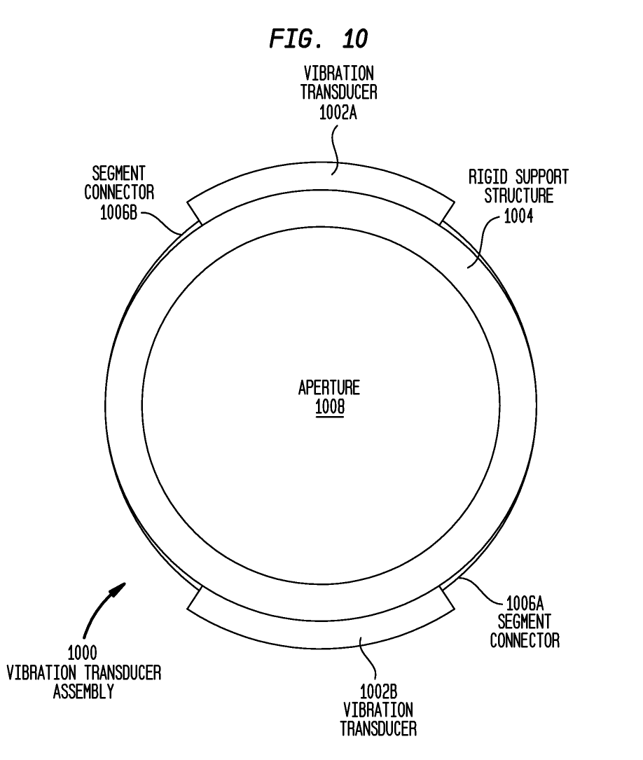

FIGS. 9 and 10 are embodiments of vibration transducer assembly 108, 308, referred to herein as vibration transducer assembly 900 and vibration transducer assembly 1000. Vibration transducer assembly 900 and vibration transducer assembly 1000 each comprise a plurality of circumferentially-spaced vibration transducers. Vibration transducer assembly 900 comprises four vibration transducers 902A-902D while vibration transducer assembly 1000 comprises two vibration transducers 1002A and 10002B. In vibration transducer assembly 900, vibration transducers 902 are relatively or substantially straight or linear whereas in vibration transducer assembly 1000, vibration transducers 1002A and 1002B are curved. From one perspective, a contiguous vibration transducer is divided into a plurality of independently or collectively controlled segments. As such, vibration transducers 902, 10002 are at times referred to herein as segments, vibration segments, at the like.

Segment connectors 1004A and 1004B connect the vibration transducers 1002 to each other to form a desired shape having an aperture. Here, the shape approximates a circle although it should be appreciated that vibration transducer 1000 may take on other non-occluding configurations appropriate for the particular recipient and conditions.

In certain embodiments, segment connectors 1004A, 1004B are formed of relatively stiff material such as wire or plastic. In one embodiment, for example, segment connectors 1004A and 1004B are 14-16 gauge stainless steel wires.

Segment connectors 1004A, 1004B are preferably malleable so that device 1000 may be conformal to the recipient's ear canal. This is described in greater detail below.

As with vibration transducer 802, vibration transducers 902, 1002 expand; that is, they are expansile transducers. In such embodiments, rigid support structures 904, 1004 which are stiffer than ear canal 510 are utilized to provide a fixed surface for expansile transducers 902, 1002 to anchor to, so that their outward radial movement 704 of vibration displacement is maximized. As noted above with reference to FIGS. 6A-6C, vibrating component 602 has a pass-through aperture 610. Accordingly, rigid support structures 904, 1004 have an aperture 9008, 1008, respectively, which forms pass-through aperture 610.

In vibration transducer assembly 900, vibration transducers 902 are embedded in rigid support structure 904, whereas in vibration transducer assembly 1000, vibration transducers 1002 are secured to the peripheral surface of rigid support structure 1004 by segment connectors 1006A and 1006B. It should be appreciated that in alternative embodiments, vibration transducers 902, 1002 and others may be secured to a rigid support structure 904, 1004, and others, using a variety of techniques, including glues, mechanical coupling, etc. For example, in one embodiment, vibration transducers 902, 1002 are mounted onto the outside of a hollow mould made with Lucite or silicone using traditional hearing aid molding techniques, first taking an impression of ear canal 510. Vibration transducers 902, 1002 may be glued to the mold with epoxy resin or other industrial strength biocompatible glues.

In certain embodiments, a rigid support structure is secured to the vibration transducer. The rigid support structure substantially prevents or minimizes vibration transducers 902, 1002 from distending radially inward during vibration. Rather, the radial forces generated by vibrating transducers 902, 1002 are exerted outward. Because vibrating component 602 is sized to fit within ear canal 510, such radial forces are delivered directly to cartilaginous ear canal 550 and/or bony ear canal 552. Such embodiments increase the efficiency of the implementing hearing device.

In an alternative embodiment, each vibrator segment 902, 1002 may have a dedicated rigid support structure secured to the segment and, perhaps, its associated segment connectors. It should be appreciated that rigid support structure 904, 1004 may be formed of any sufficiently rigid material to prevent the transducer from expanding radially inward. Examples of such materials include, but are not limited to, stainless steel, acrylic plastic, and other materials and composite materials now or later developed.

It should be appreciated that in those embodiments in which segmented vibrating transducers are implemented, transducer driver 106, 306B and power source (not shown) may be implemented differently than described above. For example, in one embodiment, multiple transducer drivers 106, 306B, one for each segment or group of segments, may be implemented. Also, multiple power sources may be implemented, each dedicated to one or more segments. Also, transducer drivers 106, 306B may require phase matching to prevent phase cancellation effects.

It should be appreciated that any quantity of segments suitable for the intended purpose may be implemented. It should also be appreciated that the segments may take on any dimension or shape, and that not all segments of a given vibration transducer assembly must have the same shape and dimensions.

In the above examples, the vibration transducers were referred to as being piezoelectric transducers. It should be appreciated, however, that other vibrations transducers may be implemented in alternative embodiments of the present invention. For example, in one embodiment, the vibration transducers are magnetorestrictive transducers such as Terfenol and galfenol.

In a further embodiment, rigid support structure 904, 1004 may be configured to serve as the above-noted segment connector between the separate vibration transducers. Non-occluding in-the-canal vibrating component 602 may be inserted quite deeply into ear canal 510; that is, to a point that is greater than 30% of the length of boney canal 552. This is illustrated in FIG. 6B. Advantages of such deep insertion include, but are not limited to, easier retention and improved contact with bone for bone conduction. Disadvantages may include that it is more difficult to fit, and more likely to cause trauma to the skin of ear canal 510. A deep insertion is also likely to result in interruption of the normal migration of the squamous epithelium of ear canal 510.

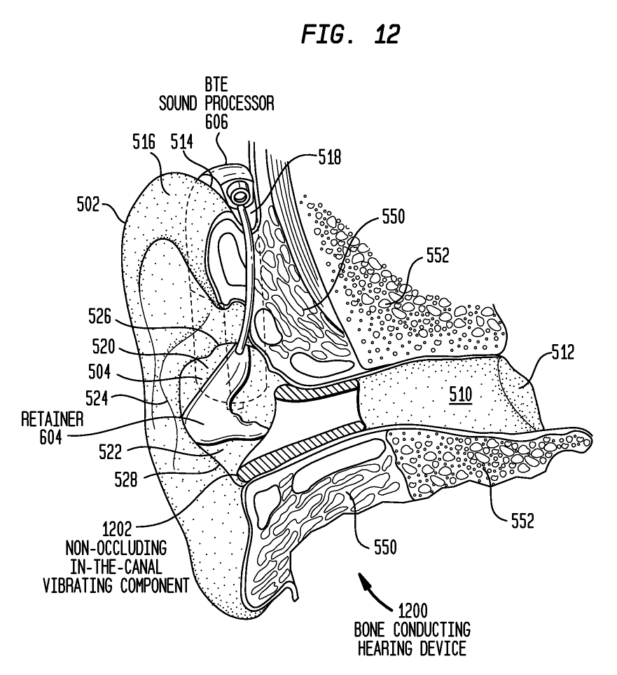

FIG. 12 is a perspective view of an alternative embodiment of the bone conducting hearing device of the present invention, referred to herein as hearing device 1200. Hearing device 1200 comprises a non-including in-the-canal vibrating component 1202 that is of shorter length than the analogous vibrating component 602 illustrated in FIG. 6B and described above.

When vibrating component 1202 is implanted in a recipient's ear canal 510, it is located only within cartilaginous ear canal 550, and does not enter or physically contact bony ear canal 552. It is understood, however, that vibrating component 1202 may be successfully implemented as a component of a bone conducting hearing device due to the intimate and tight connection between cartilage 550 of ear canal 510 and adjacent bone 552.

As noted, vibrating component 602, 1202 are implanted in ear canal 510. However, the size of ear canal 510 varies among potential recipients. This may be due to, for example, surgical modification or physiological variations. Customization of the size of vibrating components 602, 1202 is preferable to optimize mechanical coupling to ear canal 510. Proper sizing of vibrating component 602, 1202 also improves comfort and avoids trauma to the epithelium of ear canal 510.

As noted above, vibrating component 602, 1202 may be customized to the ear canal 510 of the recipient by over-molding the active or passive vibrating element 108, 208, 308B. Such over-molding may be performed using standard hearing aid custom molding techniques. It should be appreciated, however, that such over-molding is just one approach to ensuring vibrating components 602, 1202 are optimally fitted to a particular ear canal 510. Embodiments of vibrating components 602, 1202 which are adjustable in size may be implemented in addition to, or alternatively to, over-molding. Exemplary embodiments of such an adjustable vibrating component are described next below.

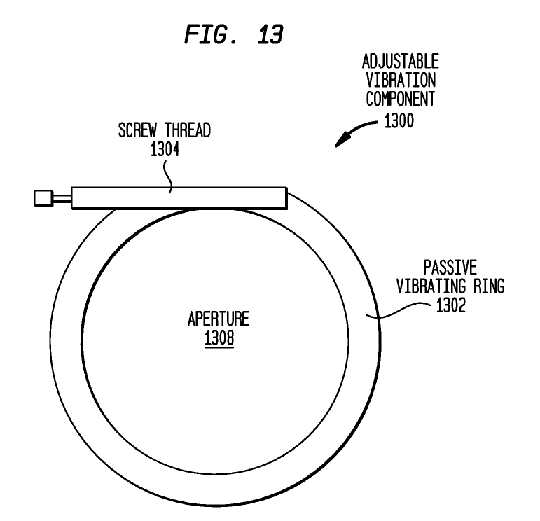

FIG. 13 is a front view of an adjustable embodiment of vibration component 602 implementing vibrating element 218, referred to herein as vibration component 1300. Adjustable vibration component 1300 comprises an adjustable passive vibrating ring 1302 having a screw thread 1304. Screw thread 1304 may be adjusted to conform vibrating element 1302 to the shape and size of ear canal 510. However, this is unsuitable for active elements in the ear canal mounting; that is, vibrating transducer assemblies 108, 308B, unless they are separated and protected by individual casings, since changing the conformation of an active vibrating ring such as vibration transducer assembly 800, may cause the device to fracture due to the rigidity of piezoelectric ceramics.

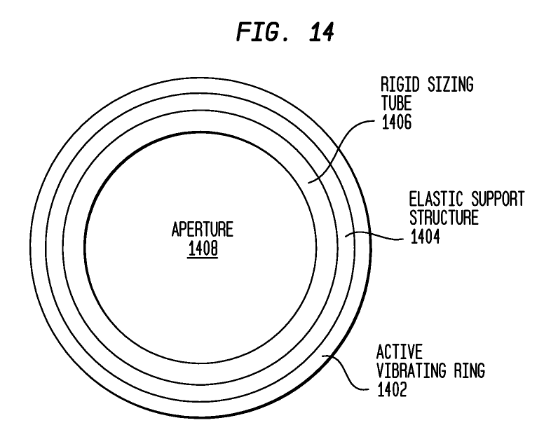

FIG. 14 is a front view of an adjustable embodiment of vibration component 602, 1202 implementing vibration transducer assembly 108, 308B, referred to herein as vibration component 1400. Adjustable vibration transducer assembly 1400 is conformable to the size of ear canal 510. Adjustable vibration transducer assembly 1400 comprises an active vibration transducer assembly 108, 308B in the form of an active vibrating ring 1402. Vibrating ring 1402 may be mounted on an elastic support structure 1404 that is configured to be dilated to fit ear canal 510 by insertion of a rigid sizing tube 1406 through aperture 1408 in the center. Rigid sizing tube 1406 may be provided in different sizes for ear canals of different sizes.

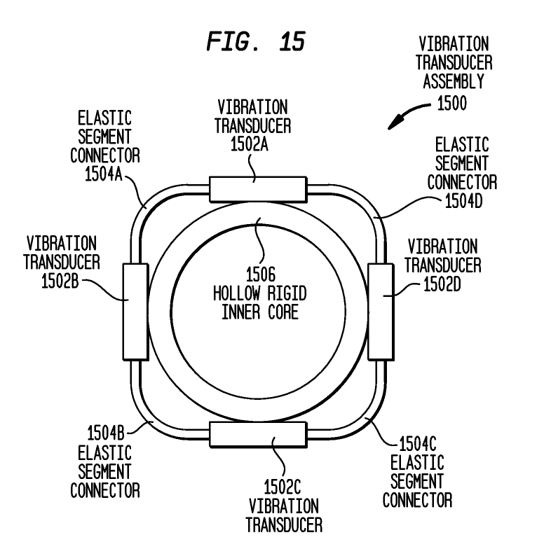

FIG. 15 is a front view of an adjustable embodiment of vibration component 602, 1202 implementing vibration transducer assembly 108, 308B, referred to herein as vibration component 1500. Adjustable vibration transducer assembly 1500 is conformable to the size of ear canal 510.

In this embodiment, vibration transducer assembly 1500 comprises a plurality of vibration transducers 1502A-1502D bonded with elastic segment connectors 1504A-1504D made of, for example, rubber. A hollow rigid cylindrical inner core 1506 made of a polymer or metal such as aluminum and titanium is then chosen to fit the size of ear canal 510. Assembly 1500 may be stretched to fit on inner core 1506, and then bonded into place with epoxy glue.

Each vibration transducer 1502 may also be bonded individually onto inner core 1506 without the elastic rubber; however, elastic segment connectors 1504 allow the mounting to be performed easily with substantially equal circumferential spacing between neighboring vibration transducers 1502.

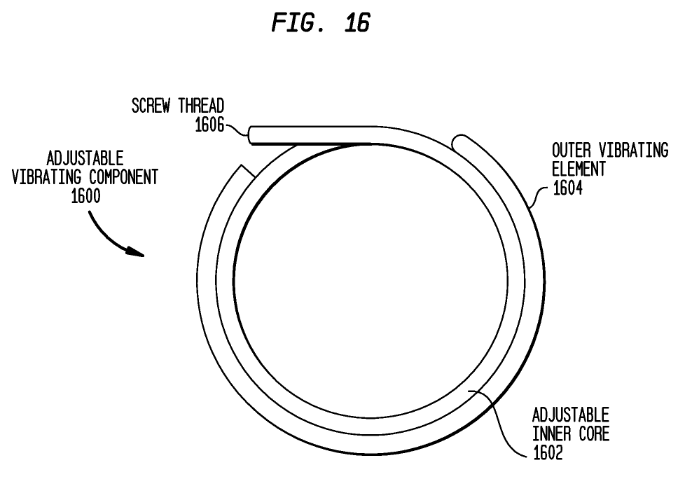

FIG. 16 is a front view of an adjustable embodiment of vibration component 602, 1202 implementing vibrating element 218, referred to herein as vibration component 1600. Adjustable vibration component 1600 comprises an adjustable inner core 1602 having a screw thread 1604. An outer vibrating element 1604 circumferentially surrounds inner core 1602.

Outward adjustment of the size of inner core 1602 via screw thread 1604 causes vibrating element 1604 to expand. In this embodiment, vibrating element 1604 is formed of a memory material. As such, inward adjustment of the size of inner core 1602 via screw thread 1604 allows vibrating element 1604 to contract. Alternatively, outer vibrating element 1604 may be formed of a memory material configured to expand to fit ear canal 510 and which would retain the expanded size. In such embodiments, the mechanism for expanding the vibrating element may be removed from ear canal 510 once a desired size is attained. Such memory materials include, for example, metals such as nitinol, although there are others.

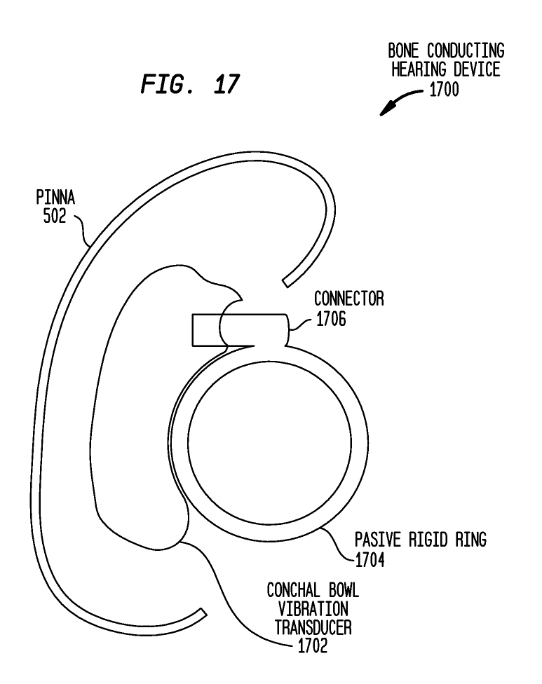

As noted above with reference to FIG. 2, in one embodiment, bone conducting hearing device 200 comprises a vibration transducer 216 configured to be located in conchal bowl 504, which controls 220 a non-occluding passive vibrating element 218 located in ear canal 510. An exemplary implementation of hearing device 200 is illustrated in FIG. 17.

FIG. 17 is a schematic diagram of an embodiment of hearing device 200, referred to herein as bone conducting hearing device 1700. Hearing device 1700 comprises passive vibrating ring 1704. Passive vibrating ring 1704 is an embodiment of vibrating element 218 and is formed of a passive rigid material and is configured to be operationally located in ear canal 510.

Hearing device 1700 further comprises an embodiment of conchal bowl vibration transducer 217, shown as vibration transducer 1702 configured to be located in conchal bowl 504. Passive rigid ring 1704 is physically connected to vibrating transducer 1702 via a connector member 1706. Connector 1706 may be encased in the rigid plastic or polymer housing of vibration transducer 1702 so that they efficiently transmit vibrations emanating in vibration transducer 1702 to passive ring 1704 in ear canal 510. In such embodiments, vibration transducer 1702 may comprise substantially larger components thereby producing substantially larger amplitude vibrations. Such vibrations are passively transmitted to ear canal ring 1704.

In the above description of hearing device 1700, sound processor 204 was not described. Sound processor 204 may reside in the housing positioned in conchal bowl 504. Such an implementation would make hearing device 1700 an embodiment of bone conducting hearing device 600B described above with reference to FIG. 6C. Alternatively, sound processor 204 may be implemented in a behind-the-ear unit. Such an implementation would make hearing device 1700 an embodiment of bone conducting hearing device 600A described above with reference to FIG. 6A.

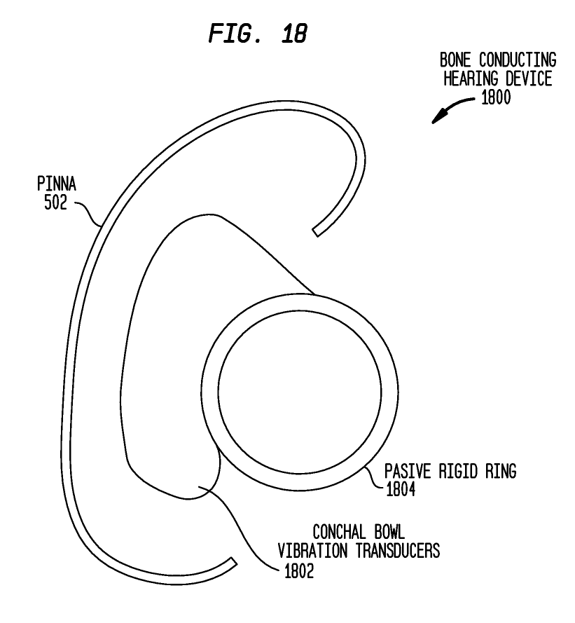

Alternatively, vibrating transducer 1702 may be housed in a behind-the-ear unit along with sound processor 204. In a further embodiment, vibrating transducer 1702 is housed in a behind-the-ear unit while sound processor 204 is housed in a conchal bowl housing. As noted above with reference to FIG. 3B, in one embodiment, bone conducting hearing device 350 comprises a vibration transducer 316A configured to be located in the conchal bowl, which delivers vibrations to the conchal bowl, and a vibration transducer 316B also configured to be located in the conchal bowl to drive a passive vibrating element 318 located in the ear canal. An exemplary implementation of hearing device 350 is illustrated in FIG. 18.

FIG. 18 is a schematic diagram of an embodiment of hearing device 350, referred to herein as bone conducting hearing device 1800. Hearing device 1800 comprises a housing configured to be operationally located in conchal bowl 504. Disposed in the housing is an embodiment of conchal bowl vibration transducer 316A and an embodiment of conchal bowl vibration transducer 316B. As noted above, vibration transducer 316A transmits vibrations directly to the skull via the conchal bowl. Vibration transducer 316B transmits vibrations to the skull via an embodiment of vibrating element 318, a passive rigid ring 1804.

Thus, in this exemplary embodiment, the entire assembly, including the portion 1804 inside ear canal 510 and the portion 1802 inside conchal bowl 504 all actively vibrates. Advantageously, a larger vibration transducer may be implemented in this embodiment as compared to other embodiments. As one of ordinary skill would appreciate, sound processor 304 may control vibration transducers 316A, 316B so as to properly manage any resonances and/or interactions between the two vibration transducers. It should also be appreciated that this embodiment may result in radiation of acoustic energy from pinna 502, resulting in some transmission of sound outside ear canal 510 and increased feedback.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom. For example, throughout the above descriptions, a microphone 102 has been referenced. It should be appreciated, however, that a sound pick-up device now or later developed may be used, and that such devices are considered to be included in the definition of the term “microphone.”

All documents, patents, journal articles and other materials cited in the present application are hereby incorporated by reference.

What is claimed is:

1. A self-retaining bone conduction hearing device comprising:
a sound processor; and
a non-occluding in-the-canal vibrating component responsive to said sound processor and configured for non-surgical-implantation in a recipient's ear canal.
